(19) United States
(12) Patent Application Publication
(10) Pub. No.: US 2005/0254524 A1
(43) Pub. Date: Nov. 17, 2005

(54) Method for sharing audio/video content over network, and structures of sink device, source device, and message

(75) Inventor: Cheol-hong An, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/121,204

(22) Filed: May 4, 2005

(30) Foreign Application Priority Data
May 12, 2004 (KR) 10-2004-0033382

(51) Int. Cl. H04H 1/04

(52) U.S. Cl. 370/487

(57) ABSTRACT

A method of sharing audio/video (A/V) content in a network, a sink device, a source device, and the structure of a message. The method of sharing the A/V content via the network includes: receiving information regarding the sharing state of the A/V content from a source device, which provides the A/V content; transmitting a request to transmit the shared A/V content, to the source device; and receiving the shared A/V content from the source device in response to the request. Accordingly, it is possible to share content with a plurality of devices in the network. Particularly, by providing a content sharing configuration in a receiving device having a user interface, more varied scenarios may be provided.

### BACKGROUND OF THE INVENTION

This application claims priority from Korean Patent Application No. 10-2004-0033382, filed on May 12, 2004, in the Korean Intellectual Property Office, the disclosure of which is incorporated herein in its entirety by reference.

1. Field of the Invention

The present invention relates to a method for sharing audio/video (A/V) content over a network, and structures of a sink device, a source device, and a message.

2. Description of the Related Art

An increasing number of digital products are being produced due to the development and spread of digital technology. For example, digital versatile discs (DVD), cable set-top boxes (STB), DVD/video cassette recorders (DVCR), digital televisions (DTV), and personal computers (PC) are all connected to a single network. A home network standard to control these interconnected devices is defined by the digital home working group (DHWG).

Recently, the environment for multimedia within the home network may be categorized into three worlds: a PC Internet world, a mobile world, and a consumer electronics (CE) broadcast world.

FIG. 1 is a view to explain the conventional home network environment according to the DHWG. A PC Internet world 100 includes a PC and PC peripheral telecommunication devices. In more detail, it includes, for example, a PC 101, a game console 102, a printer 103, a digital imaging device 104, a digital music device 105, and a wireless monitor 106.

A mobile world 110 includes, for example, a laptop 111, a multimedia mobile phone 112, and a personal digital assistant (PDA) 113. Such mobile devices provide users with the freedom to move around both inside and outside the home, while connected to the network.

A CE broadcast world 120 includes a TV monitor 121, conventional consumer electronics such as a personal video recorder (PVR), a tuner, a STB 122, and a stereo set 123.

Consumers may want to link and operate the devices in the three domains together within the household. However, research on home networks is required to connect the three worlds together and provide interoperability.

A digital home is configured in a network of CE, mobile, and PC devices.

Such network worlds need to cooperate with each other for transparency, simplicity, and continual interoperability. In addition, such a network is based on Internet Protocol (IP) networking and universal plug and play (UPnP) technologies.

Media management and control using UPnP audio/video technology makes it possible for devices and applications to distinguish, manage, and distribute media content in the home network. Also, the media content can be transmitted to a mobile device.

UPnP is an architecture for peer-to-peer network connection of, for example, intelligent applications, wireless devices, and PCs. It is versatile and easy to use in a small-size network, for example, home or small business, and is designed to provide a connection based on the standard. The UPnP architecture defines general interaction between an UPnP control point and UPnP devices. The UPnP architecture allows the devices to support content and transmission protocols in any form. UPnP devices include a TV, VCR, compact disc (CD)/DVD player, STB, stereo system, Motion Picture Experts Group (MPEG) audio layer 3 (MP3) player, still camera, camcorder, PC, and so on. An A/V architecture allows devices to support content of different formats (e.g., MPEG2, MPEG4, Joint Photographic Experts Group (JPEG), MP3, bitmap (BMP), and Window media architecture (WMA)) and transmission protocols of various types (e.g. Institute of Electrical and Electronics Engineers (IEEE)-1394, Hyper Text Transfer Protocol (HTTP) GET, Real-Time Transport Protocol (RTP), HTTP PUT/POST, and Transmission Control Protocol (TCP)/IP).

The majority of UPnP A/V scenarios include transmitting content (e.g., movies, music, and pictures) from one device to another device. An A/V control point interacts with at least two UPnP devices that act as a source and a sink.

A media server has content a user wants to transmit to another device. The media server may include or access a plurality of types of content. The media server accesses the content and transmits them to another device via a network, using a predetermined transmission protocols. Examples of the media server include, a VCR, CD/DVD player, camera, camcorder, PC, STB, satellite receiver, audio tape player, and so on.

A media server control point controls and manages an operation of the media server set by a user to perform the operation (e.g., reproduction) the user wants to perform. Also, the media server control point provides a user interface so that the user can interact with the devices to control the devices. Examples of the media server control point include, a TV having a general remote control, and a wireless PDA device. In addition, when required by the user, the media server control point may control the flow of content by invoking various A/V transmission actions such as stop, pause, fast forward, rewind, and skip.

In the home network environment illustrated in FIG. 1, the user may wish to share certain content with more than two devices via the network. For example, the user watching a video on a TV in the living room may want to watch the same video through a PC in another room. Therefore, a method of sharing A/V content with a plurality of devices via the network is required.

### SUMMARY OF THE INVENTION

The present invention provides a method of sharing A/V content, a sink device, a source device, and the structure of a message, all of which allow sharing of the A/V content via a network.

According to an aspect of the present invention, there is provided a method of sharing A/V content through a network. The method includes: receiving information regarding the sharing state of the A/V content from a source device which provides the A/V content; transmitting a request for the shared A/V content, to the source device; and receiving the shared A/V content from the source device in response to the request. P The request for the shared A/V content is generated by a sink device that desires to share the A/V content.

The transmitting of the request may include transmitting a request which designates a sharing mode which indicates the sharing type of the A/V content.

The sharing mode includes a new mode that requests the A/V content to be transmitted independently, regardless of the A/V content being transmitted to another sink device, a superimposition mode that requests the shared A/V content being transmitted to another sink device to be transmitted in superimposition, and a redirection mode that requests the shared A/V content being transmitted to another sink device to be transmitted in succession and stops the transmission to the another sink device.

According to another aspect of the present invention, there is provided a method of sharing A/V content through a network. The method includes: receiving a request from a second sink device to transmit the A/V content being transmitted to a first sink device thereto; and transmitting the A/V content being transmitted to the first sink device to the second sink device in response to the request.

The receiving of the request may include transmitting a request which designates a sharing mode which indicates the sharing type of the A/V content with the first sink device.

The sharing mode includes a new mode that requests the A/V content to be transmitted independently, regardless of the A/V content being transmitted to the first sink device, a superimposition mode that requests the shared A/V content being transmitted to the first sink device to be transmitted in superimposition, and a redirection mode that requests the shared A/V content being transmitted to the first sink device to be transmitted in succession and stops the transmission to the first sink device.

According to another aspect of the present invention, there is provided a sink device for sharing A/V content in a network. The sink device includes: a first processor to request information on the A/V content to a source device, which provides the A/V content, and receive information on another sink device that is sharing the A/V content in response to the request; and a second processor to generate and transmit a request message to transmit the share A/V content to the source device, and receive the shared A/V content from the source device in response to the request.

The second processor may designate a sharing mode which indicates the sharing type of the A/V content with the another sink device, in the request message.

The first processor may be configured as a media server control point, and the second processor may be configured as a streaming client.

According to another aspect of the present invention, there is provided a source device for sharing A/V content in a network. The source device includes: a first processor to transmit information on the sharing state of the A/V content to a second sink device in response to a request of the second device which requests the transmittance of the information on the A/V content being transmitted to a first sink device; and a second processor to transmit the A/V content being transmitted to the first sink device to the second sink device in response to the request of the second sink device.

The second processor may receive a request which designates a sharing mode which indicates the sharing type of the A/V content with the first sink device.

The first processor is configured as a media server control point, and the second processor is configured as a streaming client.

According to another aspect of the present invention, there is provided a structure of a response message of a sink device for responding to an A/V content information request transmitted to a source device from a sink device, to share the A/V content via a network. The structure of the response message includes: a type field of the requested A/V content; and a sharing device identifier field indicating the sharing device which shares the A/V content with the source device.

The response message may use a hyper text transfer protocol (HTTP) response message.

According to another aspect of the present invention, there is provided a structure of a response message for an A/V content information request transmitted to a source device from a sink device, to share the A/V content via a network. The structure of the response message includes: an information field for identifying A/V content that desires to be shared; a sharing mode field that shows the sharing type of the A/V content with another sink device; and a device identifying field to identify a sink device transmitting the request message.

The response message may use an HTTP response message.

The sharing mode includes a new mode that requests the A/V content to be transmitted independently, regardless of the A/V content being transmitted to the another sink device, a superimposition mode that requests the shared A/V content being transmitted to the another sink device to be transmitted in superimposition, and a redirection mode that requests the shared A/V content being transmitted to the another sink device to be transmitted in succession and stops the transmission to the another sink device.

### BRIEF DESCRIPTION OF THE DRAWINGS

The above and other aspects of the present invention will become more apparent by describing in detail exemplary embodiments thereof with reference to the attached drawings in which:

FIG. 1 is a view to explain the conventional home network environment according to the digital home working group (DHWG);

FIG. 2 is a structural diagram of a system sharing digital content through a network according to an exemplary embodiment of the present invention;

FIG. 3 is a schematic structural diagram of a source device of FIG. 2;

FIG. 4 is a schematic structural diagram of a sink device of FIG. 2;

FIG. 5 is a view of a response message the source device transmits to the sink device according to an exemplary embodiment of the present invention;

FIG. 6 is a view of an exemplary content request message the sink device transmits to the source device according to an exemplary embodiment of the present invention;

FIG. 7 is a view of another exemplary content request message the sink device transmits to the source device according to an exemplary embodiment of the present invention;

FIG. 8 is a view illustrating the operation of a superimposition mode among methods of sharing digital content through a network, according to an exemplary embodiment of the present invention;

FIG. 9 is a view illustrating the operation of a redirection mode among the methods of sharing the digital content through the network, according to an exemplary embodiment of the present invention;

FIG. 10 is a view illustrating the operation of a new mode among the methods of sharing the digital content through the network, according to an exemplary embodiment of the present invention;

FIG. 11 is a view of an exemplary HTTP head information request message;

FIG. 12 is a view of an exemplary HTTP head information response message;

FIG. 13 is a view of an exemplary HTTP content request message;

FIG. 14 is a view of another exemplary HTTP head information response message;

FIG. 15 is a view of another exemplary HTTP content request message; and

FIG. 16 is a view of yet another exemplary HTTP content request message.

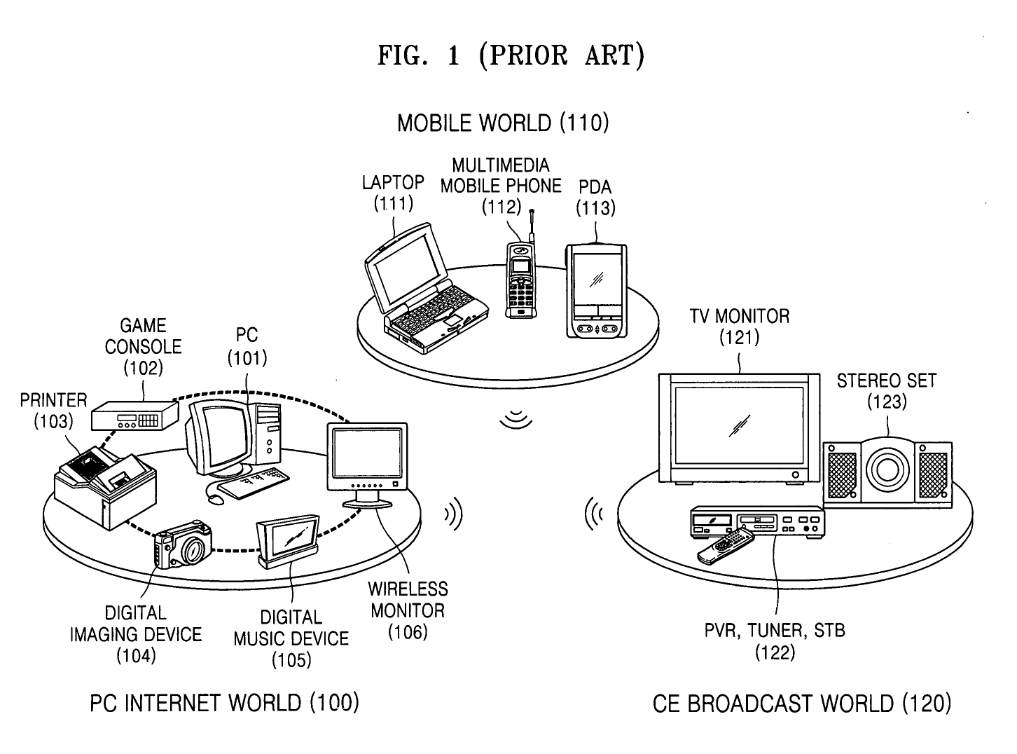

### DETAILED DESCRIPTION OF THE EXEMPLARY EMBODIMENTS OF THE INVENTION

The present invention will now be described more fully with reference to the accompanying drawings, in which exemplary embodiments of the invention are shown.

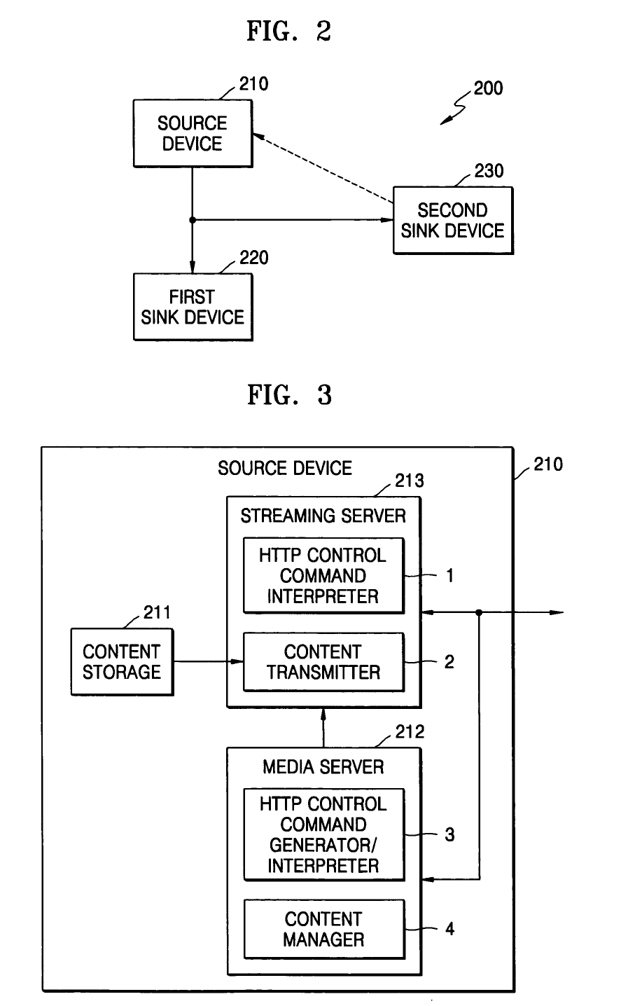

FIG. 2 is a structural diagram of a system 200 sharing digital content through a network according to an exemplary embodiment of the present invention. A source device 210 receives an A/V content request from a first or second sink device 220 or 230 and sends A/V content to the first or second sink device 220 or 230 that requested it.

The first sink device 220 gets information on the A/V content from the source device 210, requests the A/V content, and receives and utilizes the A/V content from the source device 210.

The second sink device 230 has the same role as the first sink device 220. For example, the first sink device 220 may be a TV in the living room, and the second sink device 230 may be a PC in another room.

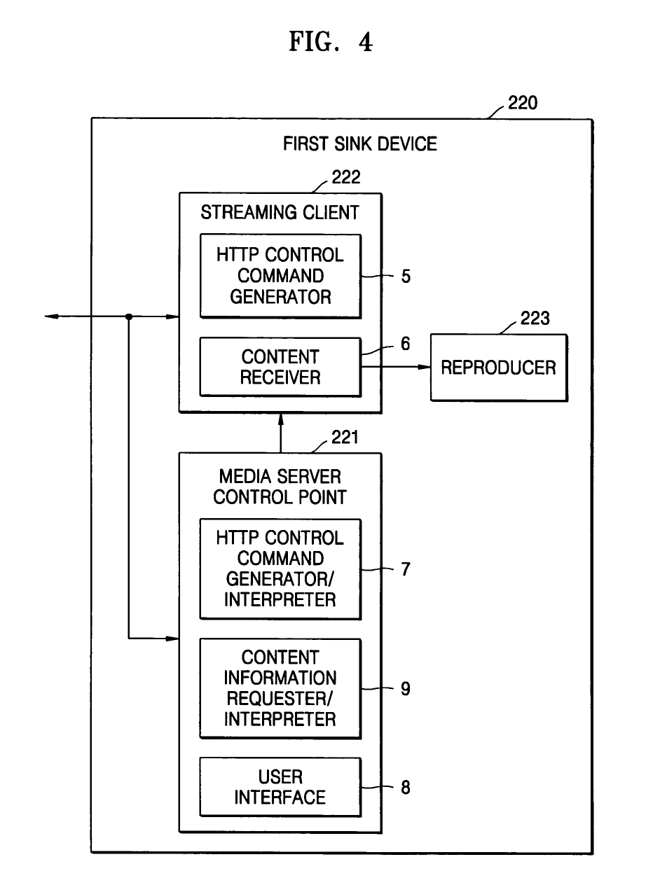

The first sink device 220 requests and receives the A/V content from the source device 210 and utilizes the content. To share the A/V content utilized by the first sink device 220, the second sink device 230 gets information on the A/V content to be shared from the source device 210 and also requests and receives the A/V content. Here, the source device 210 provides information on the sharing state of a device of the requested A/V content, and the first or second sink devices 220 and 230 select a desired sharing mode with reference to the information on the sharing state. This process will be described in more detail with reference to FIGS. 3 and 4.

FIG. 3 is a schematic structural diagram of the source device 210 of FIG. 2. The source device 210 is composed of a content storage 211, a media server 212, a streaming server 213. Of course, the content storage 211 may be included in the streaming server 213 or the media server 212.

The content storage 211 stores the A/V content. The media server 212 includes a hyper text transfer protocol (HTTP) control command generator/interpreter 3 and a content manager 4.

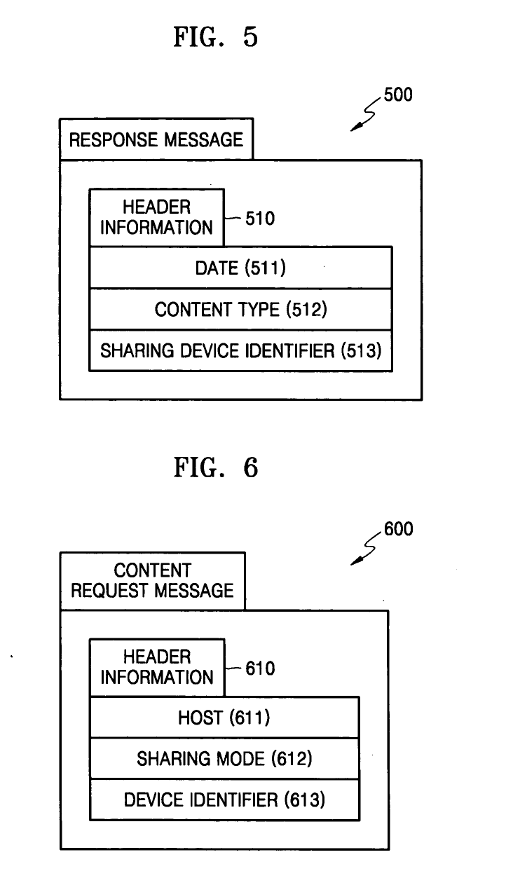

The HTTP control command generator/interpreter 3 generates an HTTP control command according to the present invention and transmits it to the first and second sink devices 220 and 230, interprets an HTTP control command received from the first and second sink devices 220 and 230 and performs an appropriate process. Particularly, according to the present invention, if the HTTP control command generator/interpreter 3 has received an information request message from the first and second sink devices 220 and 230, the information request message is interpreted, and the HTTP control command generator/interpreter 3 generates a response message like the one illustrated in FIG. 5 to provide information on the content in response to the request message.

Referring to FIG. 5, a response message 500 includes a date 511, content type 512, and a sharing device identifier 513 as header information 510. The date 511 represents the date the response message 500 is sent. The content type 512 is information on the type of the requested content, etc. The sharing device identifier 513 is an identifier that indicates a device which is sharing the requested content with the source device 210 in the present state. In other words, the sharing device indicates a sink device that receives the requested content from the source device. By inserting the sharing device identifier 513 in the response message 500, the first or second sink device 220 or 230 knows to which sink device the source device 210 is currently transmitting the content.

The content manager 4 manages the content stored in the content storage 211, and particularly manages information on the content. That is, if the content manager 4 receives a command requesting the information on the content from a media server control point of the sink device, the content manager 4 searches for the information on the content and transmits the information on the content to the first or second sink device 220 or 230. The HTTP control command generator/interpreter 3 refers to the information on the content the content manager 4 manages when generating response messages such as the response message 500 of FIG. 5.

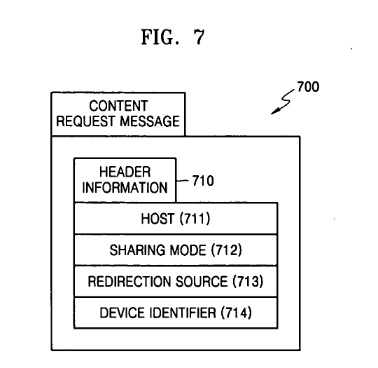

The streaming server 213 includes an HTTP control command interpreter 1 and a content transmitter 2. The HTTP control command interpreter 1 receives the HTTP control command from the first or second sink device 220 or 230 and interprets it. Particularly, according to an exemplary embodiment of the present invention, the HTTP control command interpreter 1 receives content request messages 600 and 700 illustrated in FIGS. 6 and 7 from the first or second sink device 220 or 230 and interprets them. In addition, the HTTP control command interpreter 1 appropriately controls the content transmitter 2 depending on the results of the interpretation.

The content transmitter 2 gets the A/V content requested by the first or second sink device 220 or 230 from the content storage 211 and transmits it to the first or second sink device 220 or 230.

FIG. 4 is a schematic structural diagram of the first sink device 220 of FIG. 2.

The first sink device 220 includes a media server control point (MSCP) 221, a streaming client 222, and a reproducer 223.

The reproducer 223 consumes the A/V content received from the source device 210.

The MSCP 221 includes an HTTP control command generator/interpreter 7, a user interface 8, and a content information requester/interpreter 9. The user interface 8 receives operation commands (e.g., play) of the A/V contents from a user. The content information requester/interpreter 9 requests content information from the source device using Browse or Search command, receives the content information from the source device, and interprets the content information. When the HTTP control command generator/interpreter 7 has received operation commands of a predetermined content from the user interface 8, it generates a content information request message to obtain information on the content. When the HTTP control command generator/interpreter 7 receives a response message to the content information request message, it interprets the response message. The HTTP control command generator/interpreter 7 transmits such information interpreted from the response message or information on the user's command received via the user interface 8 to the streaming client 222.

The streaming client 222 includes an HTTP control command generator 5 and a content receiver 6. The HTTP control command generator 5 generates an HTTP control command with reference to the information interpreted from the user's command or the content information response message, which are received from the MSCP 221. Such HTTP control commands may be content request messages 600 and 700 illustrated in FIGS. 6 and 7, which will be explained in more detail below. The content receiver 6 receives the A/V content from the source device 210 and transmits it to the reproducer 223.

FIG. 6 is a view of an exemplary content request message which the first or second sink device 220 and 230 transmits to the source device 210 according to an exemplary embodiment of the present invention. Referring to FIG. 6, the content request message 600 includes a host 611, a sharing mode 612, and a device identifier 613 as header information 610.

The host 611 indicates address information to distinguish the requested content. The sharing mode 612 indicates the method of sharing the requested content. The exemplary embodiments of the present invention provide three modes: superimposition mode, redirection mode, and new mode.

In the superimposition mode, the source device 210 transmits the A/V content to the first sink device 220, and then begins transmitting the same A/V content to the second sink device 230, in synchronization with the A/V content still transmitted to the first sink device 220. For example, the superimposition mode can be used when two users watch half a movie together through a DVD player in the living room, and then one user continues to watch in the living room while the other watches the rest of the movie on a PC in another room.

In the redirection mode, the source device 210 stops transmitting the A/V content to the first sink device 220, and instead continues transmitting the same A/V content to the second sink device 230. For example, the redirection mode can be used when a user begins watching a movie through the DVD player in the living room, and then watches the rest of the movie through a PC in the other room and wants to stop transmission to the living room.

In the new mode, the source device 210 continues transmitting the A/V content to the first sink device 220, and then independently transmits the A/V content to the second sink device 230 regardless of the A/V content transmitted to the first sink device 220. For example, the new mode can be used when a first user has watched half a movie through the DVD player in the living room, and then a second user wants to watch the same movie from the start through the PC in the other room while the first user continues to watch in the living room.

The device identifier 613 is an identifier for identifying the first and second sink devices 220 and 230, which transmits the content request messages.

FIG. 7 is a view of another exemplary content request message the first or second sink device 220 or 230 transmits to the source device 210 according to an exemplary embodiment of the present invention. Referring to FIG. 7, the content request message 700 includes a host 711, a sharing mode 712, a redirection source 713, and a device identifier 714 as header information 710. The host 711, the sharing mode 712, and the device identifier 714 are identical to those explained with reference to FIG. 6. The content request message 700 further includes the redirection source 713 field compared to the content request message 600.

The redirection source 713 is a field used when it is desired to receive the A/V content in the redirection mode, and indicates the first or second sink device 220 or 230 from which to cut off the previous connection when the A/V content are being shared. Such a field is not needed in the superimposition mode, which does not affect the previous connection. However, in the case of the redirection mode, if there were a plurality of previous connections, a decision needs to be made which previous connection to cut, thereby requiring the redirection source 713 field.

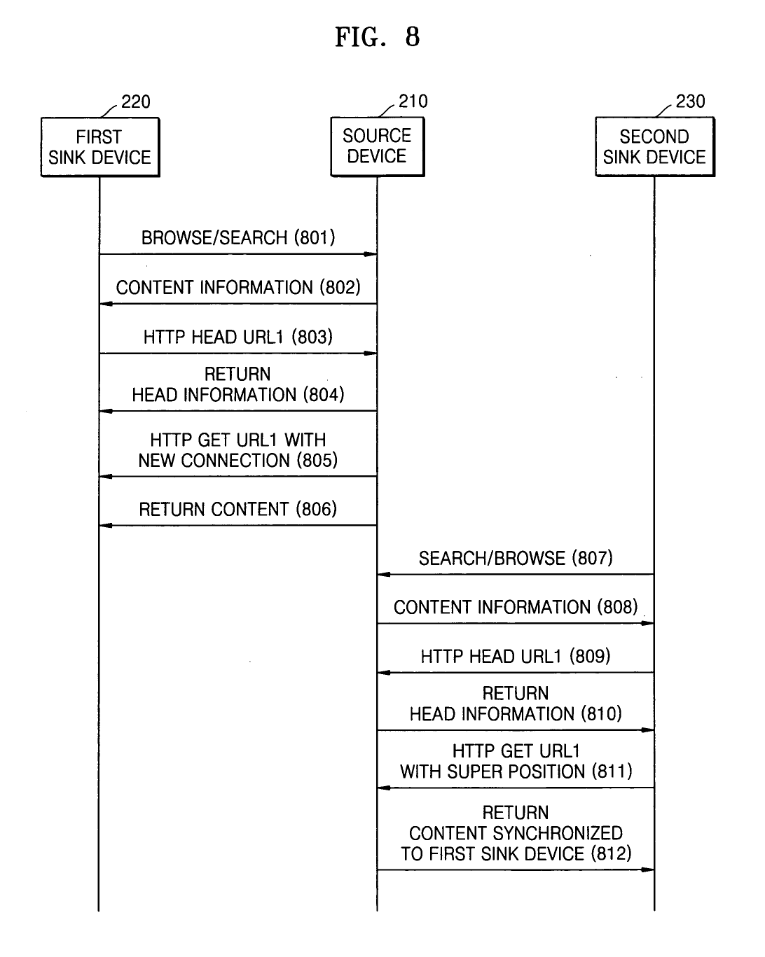

Exemplary methods of sharing the A/V content according to the previously mentioned three sharing modes will be described with reference to FIGS. 8 through 10. In these examples, it is assumed that a HTTP transmission protocol is used.

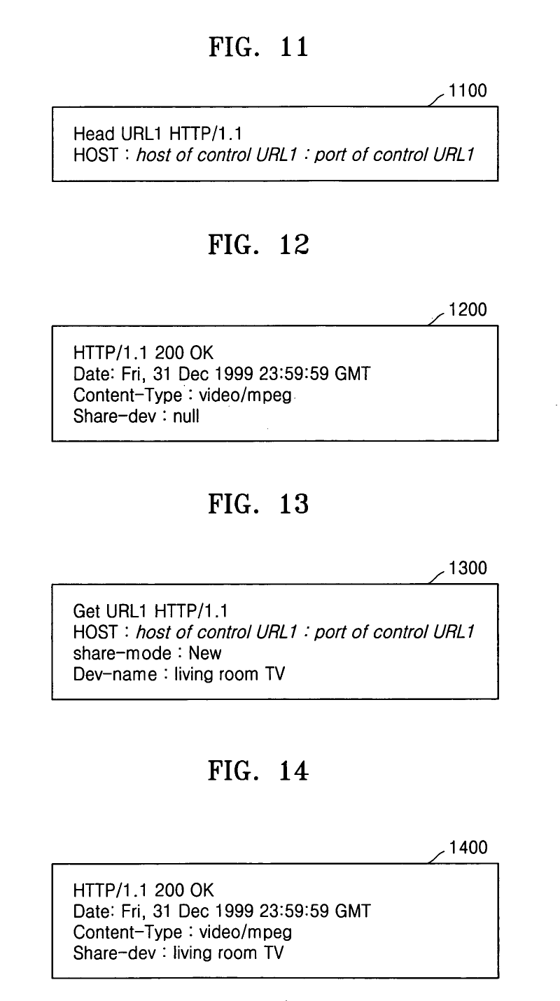

FIG. 8 is a view illustrating the operation of the superimposition mode among the methods of sharing digital content through a network, according to an exemplary embodiment of the present invention. The first sink device 220 transmits a command such as browse/search to the source device 210 to obtain the information on the content (Operation 801). The source device 210 that received the command transmits the information on the content it has to the first sink device 220 (Operation 802). The first sink device 220 checks the received information on the content and transmits an HTTP HEAD command, as illustrated in FIG. 11, to the source device 210 to obtain header information on the content the first sink device 220 desires to receive (Operation 803).

FIG. 11 is a view of an exemplary HTTP head information request message 1100. Among the HTTP request messages, the messages with HEAD as its method denotes a request for information distinguished at a uniform resource identifier (URI), and the requested information is transmitted using the header field in a response message to the HEAD.

Referring to FIG. 11, the HTTP head information request message 1100 includes a request for information identified as “URL1,” and “HOST” denotes information that identifies an Internet host. In the HOST field, “host of control URL1” and “port of control URL1” is inserted.

The first source device 210 that received the HTTP HEAD command transmits header information on the content corresponding to the URL1 to the first sink device 220 using an HTTP response message like the one illustrated in FIG. 12 (Operation 804).

FIG. 12 is a view of an exemplary HTTP head information response message 1200. The HTTP response message is composed of a state line, at least one general header, and response header, etc.

Referring to FIG. 12, the HTTP head information response message 1200 has “HTTP/1.1 200 OK” as its state line. The “HTTP/1.1” denotes the HTTP version number of the transmitting side, and “200 OK” denotes that the request has been successfully received and the requested information is included in the HTTP head information response message 1200. “DATE” literally denotes the date, “CONTENT-TYPE” literally denotes the type of the content, and “Share-dev” denotes a device that the source device 210 is sharing the current content with another device. Since the current source device 210 does not have a sink device that is receiving the content, “null” is inserted.

Meanwhile, in the present exemplary embodiment and other exemplary embodiments below, requesting header information on the content and receiving it can be explained through Operations 803 and 804 even when the first sink device 220 is requested to receive the content through the new mode. However, Operations 803 and 804 may be omitted when requesting the content in the new mode because the new mode requests the content independently regardless of the content header information received from the source device 210.

The first sink device 220, which received the response message, transmits an HTTP request message, like the one illustrated in FIG. 13, to request the content (Operation 805).

FIG. 13 is a view of an exemplary HTTP content request message 1300. Among the HTTP request messages, the messages with GET as its method denotes a request for information distinguished at a URI, and the response is returned through an entity body.

Referring to FIG. 13, the HTTP head information request message 1300 includes a request for information identified as “URL1,” and “HOST” denotes information that identifies an Internet host that provides resources. In the HOST field, “host of control URL1” and “port of control URL1” is inserted.

Particularly, the HTTP head information request message 1300 according to the present invention includes a “share-mode” field and a “Dev-name” mode to identify a device and a sharing mode. The “share-mode” denotes a mode in which the sink device desires to share the content, as described with reference to FIG. 6. Because there is no sink device that is sharing the content at present, the first sink device is the first device 220 to use the content. Therefore, “share-mode” is set to “new” mode. To be set to “new” mode means to send the content corresponding to the URL from the beginning. The “Dev-name” is to identify the device which transmits the content request message. If the first sink device 220 is a living room TV, then it is set as “living room TV.”

The source device 210 that received the HTTP request message returns the requested content to the first sink device 220 (Operation 806).

While the source device 210 transmits the A/V content to the first sink device 220, the second sink device 230 performs the following operations to receive the A/V content in the superimposition mode.

The second sink device 230 transmits commands such as browse/command to the source device 210 to obtain the information on the content (Operation 807).

The source device 210 that received the commands transmits the information on the content it has to the second sink device 230 (Operation 808).

The second sink device 230 checks the received information on the content and transmits an HTTP HEAD command, like the one illustrated in FIG. 11, to the source device 210 to obtain header information on the content the second sink device 230 desires to receive (Operation 809).

The sink device 210 that received the HTTP HEAD command transmits the header information on the content corresponding to URL1 to the second sink device 230 using an HTTP response message like the one illustrated in FIG. 14 (Operation 810).

FIG. 14 is a view of another exemplary HTTP head information response message 1400. Referring to FIG. 14, the HTTP head information response message 1400 is similar to the HTTP head information response message 1200 of FIG. 12 apart from the content of the field. That is, the source device 210 is already transmitting the A/V content to the first sink device 220. Therefore, “living room TV,” denoting the first sink device 220, is inserted in a “share-dev” field, which is to identify the sharing device.

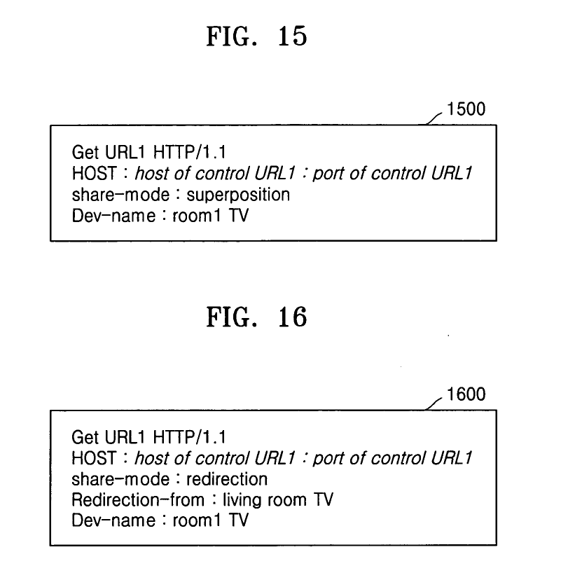

The second sink device 230 that received the HTTP head information response message 1400 transmits an HTTP request message, like the one illustrated in FIG. 15, to the source device 210 to request the content (Operation 811).

FIG. 15 is a view of another exemplary HTTP content request message 1500.

Referring to FIG. 15, the HTTP content request message 1500 similar to the HTTP content request message 1300 of FIG. 13 apart from the content of the field. That is, “superimposition” is inserted in a “share-mode” field to indicate the desire of the second sink device 230 to receive the A/V content in superimposition with the first sink device 220, and a “room 1 TV” is inserted in a “Dev-name” field to indicate which sink device is transmitting the request message.

The source device 210 that received such HTTP content request message 1500 returns the requested content to the second sink device 230 (Operation 812).

That is, the source device 210 transmits identical data synchronized with the first sink device 220 to the second sink device 230, according to the superimposition mode requested by the second sink device 230. If the source device 210 cannot provide the superimposed content, then an error message such as “resource not available” may be transmitted.

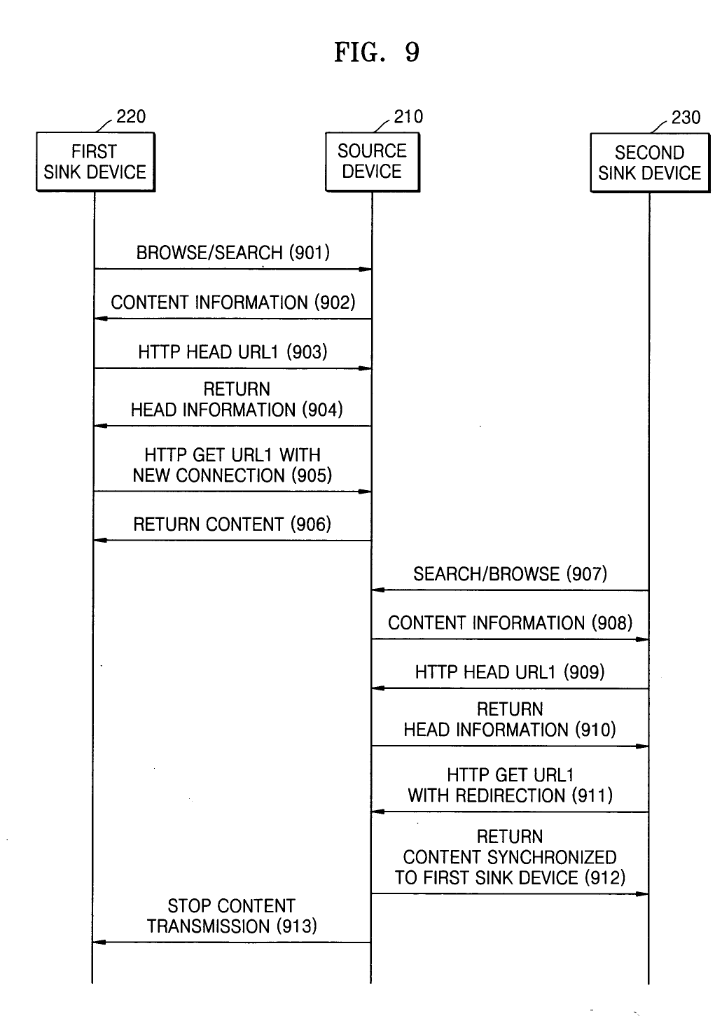

FIG. 9 is a view illustrating the operation of the redirection mode among the methods of sharing the digital content through the network, according to an exemplary embodiment of the present invention. The first sink device 220 transmits a command such as browse/search to the source device 210 to obtain the information on the content (Operation 901). The source device 210 that received the command transmits the information on the content it has to the first sink device 220 (Operation 902).

The first sink device 220 checks the received information on the content and transmits an HTTP HEAD command, like the one illustrated in FIG. 11, to the source device 210 to obtain header information on one of the content the first sink device 220 desires to receive (Operation 903).

The source device 210 that received the HTTP HEAD command transmits header information on the content corresponding to an URL1 to the first sink device 220 using an HTTP head information response message like the one illustrated in FIG. 12 (Operation 904).

The first sink device 220 that received the HTTP head information response message transmits an HTTP request message like the one illustrated in FIG. 13, to the source device 210 to request for the content (Operation 905).

The source device 210 that received the HTTP request message returns the requested content to the first sink device 220 (Operation 906).

While the source device 210 transmits the A/V content to the first sink device 220, the second sink device 230 performs the following operations to receive the A/V content in the redirection mode.

The second sink device 230 transmits commands such as browse/command to the source device 210 to the source device 210 to obtain the information on the content (Operation 907). The source device 210 that received the commands transmits the information on the content it has to the second sink device 230 (Operation 908).

The second sink device 230 checks the received information on the content and transmits an HTTP HEAD command, like the one illustrated in FIG. 11, to the source device 210 to obtain header information of one of the content the second sink device 230 desires to receive (Operation 909).

The sink device 210 that received the HTTP HEAD command transmits the header information on the content corresponding to URL1 to the second sink device 230 using an HTTP head information response message like the one illustrated in FIG. 14 (Operation 910).

The second sink device 230 that received the HTTP response message transmits an HTTP content request message like the one illustrated in FIG. 16 to request the content (Operation 911).

FIG. 16 is a view of yet another exemplary HTTP content request message 1600. Referring to FIG. 16, the HTTP content request message 1600 is similar to the HTTP content request message 1500 of FIG. 15 except for that the HTTP content request message 1600 indicates the redirection mode, not the superimposition mode, as the sharing mode. That is, “redirection” is inserted in the “share-mode” field to indicate that the second sink device 230 desires to continue receiving the A/V content the first sink device 220 was receiving, and stop the A/V content transmission to the first sink device 220. A “room 1 TV” is inserted in the “Dev-name” to identify the sink device which transmits the request message. The “Redirection-from” field indicates the redirection source, as described with reference to FIG. 7, and determines which connection is to be cut among the previous plurality of connections that were receiving the A/V content. In the HTTP content request message 1600, “living room TV” is inserted in the “Redirection-from” field to cut the connection to the first sink device 220.

The source device 210 that received the HTTP content request message 1600 returns the requested content to the second sink device 230 (Operation 912). That is, the source device 210 transmits identical data synchronized with the first sink device 220 to the second sink device 230, according to the redirection mode requested by the second sink device 230, and the source device 210 then stops the transmission of the A/V content to the first sink device 220, as is written in the redirection source field. The source device 210 may transmit an error message to the second sink device 230 if the redirection cannot be performed.

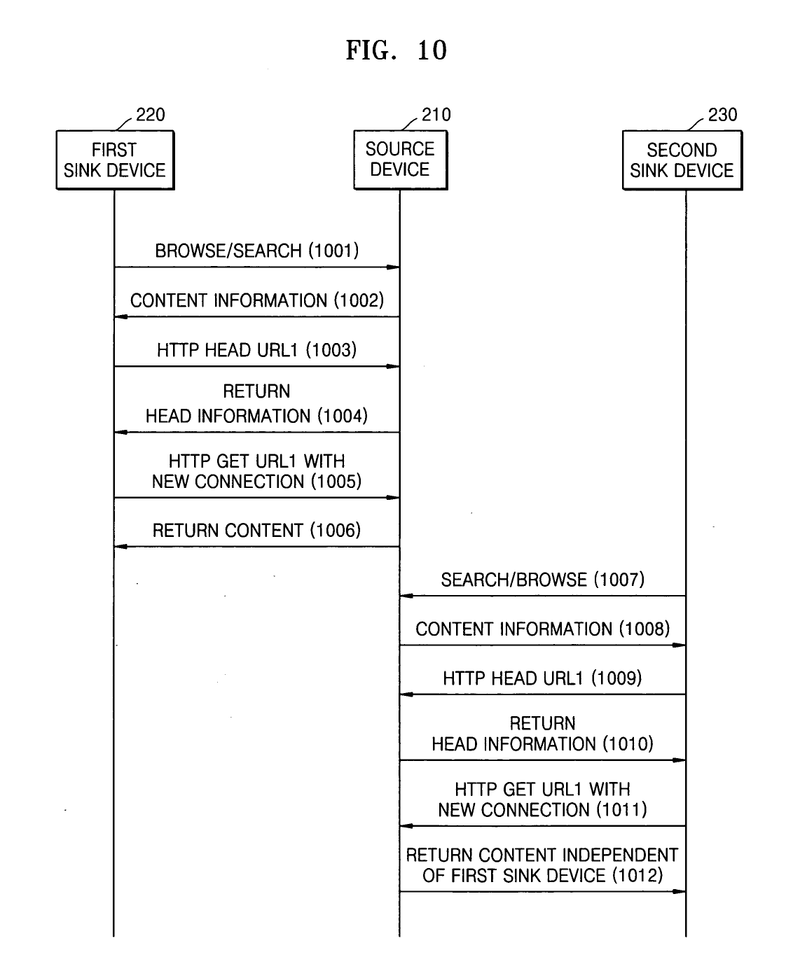

FIG. 10 is a view illustrating the operation of the new mode among the methods of sharing the digital content through the network, according to an exemplary embodiment of the present invention. The first sink device 220 transmits a command such as browse/search to the source device 210 to obtain the information on the content (Operation 1001). The source device 210 that received the command transmits the information on the content it has to the first sink device 220 (Operation 1002).

The first sink device 220 checks the received information on the content and transmits an HTTP HEAD command, like the one illustrated in FIG. 11, to the source device 210 to obtain header information on one of the content the first sink device 220 desires to receive (Operation 1003).

The source device 210 that received the HTTP HEAD command transmits header information on the content corresponding to an URL1 to the first sink device 220 using an HTTP head information response message like the one illustrated in FIG. 12 (Operation 1004).

The first sink device 220 that received the HTTP head information response message transmits an HTTP content request message like the one illustrated in FIG. 13, to the source device 210 to request for the content (Operation 1005).

The source device 210 that received the HTTP content request message returns the requested content to the first sink device 220 (Operation 1006).

While the source device 210 transmits the A/V content to the first sink device 220, the second sink device 230 performs the following operations to receive the A/V content in the new mode.

The second sink device 230 transmits commands such as browse/command to the source device 210 to the source device 210 to obtain the information on the content (Operation 1007). The source device 210 that received the commands transmits the information on the content it has to the second sink device 230 (Operation 1008).

The second sink device 230 checks the received information on the content and transmits an HTTP HEAD command, like the one illustrated in FIG. 11, to the source device 210 to obtain header information on the content the second sink device 230 desires to receive (Operation 1009).

The sink device 210 that received the HTTP HEAD command transmits the header information on the content corresponding to URL1 to the second sink device 230 using an HTTP head information response message like the one illustrated in FIG. 14 (Operation 1010).

The second sink device 230 that received the HTTP head information response message transmits an HTTP content request message, like the one illustrated in FIG. 16, to independently request the content (Operation 1011).

The second sink device 230 designates the sharing mode of the HTTP content request message, like the one illustrated in FIG. 13, as “New” and transmits it to the source device 210, even when the source device 210 is already transmitting the A/V content to the first sink device 220 and is in the sharing mode. Therefore, the second sink device 230 can independently receive the A/V content from the beginning, regardless of the A/V content being transmitted to the first sink device 220 by the source device 210.

The source device 210 that received such HTTP content request message returns the requested content to the second sink device 230 (Operation 1012). That is, the source device 210 independently transmits data to the second sink device 230 regardless of data being transmitted to the first sink device 220 according to the “new” mode requested by the second sink device 230. The source device 210 can transmit an error message to the second sink device 230 if the redirection cannot be performed.

The processing methods of the source device 210 and the first and second sink devices 220 and 230 may also be configured as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for configuring the processing methods can be easily construed by programmers skilled in the art to which the present invention pertains.

According to above-mentioned configuration of the exemplary embodiments of the present invention, content may be shared by a plurality of devices in a network. Particularly, numerous scenarios may be provided by providing a content sharing configuration in a receiving device having a user interface. Especially, the present invention provides a function of sharing the content in a 2-box model, i.e., digital media server (DMS) and a digital media player (DMP), of the digital home working group (DHWG).

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of sharing audio/video (A/V) content through a network, the method comprising:
receiving information regarding a sharing state of the A/V content from a source device, which provides the A/V content;
transmitting a request for the A/V content to the source device; and
receiving the A/V content from the source device in response to the request.

2. The method of claim 1, wherein the request for the A/V content is generated by a sink device that desires to share the A/V content.

3. The method of claim 1, wherein the transmitting of the request comprises transmitting a request which designates a sharing mode which indicates a sharing type of the A/V content.

4. The method of claim 3, wherein the sharing mode comprises a new mode that requests the A/V content to be transmitted to a sink device independently, regardless of the A/V content being transmitted to another sink device.

5. The method of claim 3, wherein the sharing mode comprises a superimposition mode that requests the A/V content, which is transmitted to another sink device, be transmitted in superimposition to a sink device.

6. The method of claim 3, wherein the sharing mode comprises a redirection mode that requests the A/V content being transmitted to another sink device be transmitted to a sink device in succession and stops the transmission to the another sink device.

7. A method of sharing audio/video (A/V) content through a network, the method comprising:
receiving a request from a second sink device to transmit the A/V content being transmitted to a first sink device to the second sink device; and
transmitting the A/V content being transmitted to the first sink device to the second sink device in response to the request.

8. The method of claim 7, wherein the receiving of the request comprises transmitting a request which designates a sharing mode which indicates a sharing type of the A/V content with the first sink device.

9. The method of claim 8, wherein the sharing mode comprises a new mode that requests the A/V content to be transmitted to the second sink device independently, regardless of the A/V content being transmitted to the first sink device.

10. The method of claim 8, wherein the sharing mode comprises a superimposition mode that requests the A/V content, which is transmitted to the first sink device, be transmitted in superimposition to the second sink device.

11. The method of claim 8, wherein the sharing mode comprises a redirection mode that requests the A/V content being transmitted to the first sink device be transmitted in succession to the second sink device and stops the transmission to the first sink device.

12. The method of claim 11, further comprising stopping the transmission of the A/V content to the first sink device.

13. A sink device for sharing audio/video (A/V) content in a network, the sink device comprising:
a first processor that requests information regarding the A/V content from a source device, which provides the A/V content, and that receives information on another sink device, which is sharing the A/V content, in response to the request; and
a second processor that generates and transmits, to the source device, a request message to transmit the A/V content, and that receives the A/V content from the source device in response to the request.

14. The sink device of claim 13, wherein the second processor designates a sharing mode which indicates the sharing type of the A/V content with the another sink device, in the request message.

15. The sink device of claim 14, wherein the sharing mode comprises a new mode that requests the A/V content to be transmitted to the sink device independently, regardless of the A/V content being transmitted to the another sink device.

16. The sink device of claim 14, wherein the sharing mode comprises a superimposition mode that requests the A/V content, which is transmitted to the another sink device, be transmitted in superimposition.

17. The sink device of claim 14, wherein the sharing mode comprises a redirection mode that requests the A/V content being transmitted to the another sink device be transmitted in succession to the sink device and stops the transmission to the another sink device.

18. The sink device of claim 13, wherein the first processor is configured as a media server control point, and the second processor is configured as a streaming client.

19. A source device for sharing audio/video (A/V) content in a network, the source device comprising:
a first processor that transmits information on a sharing state of the A/V content to a second sink device in response to a request of the second device, which requests a transmission of information regarding the A/V content being transmitted to a first sink device; and
a second processor that transmits the A/V content, which is transmitted to the first sink device, to the second sink device in response to the request of the second sink device.

20. The source device of claim 19, wherein the second processor receives a request which designates a sharing mode which indicates the sharing type of the A/V content with the first sink device.

21. The source device of claim 20, wherein the sharing mode comprises a new mode that requests the A/V content to be transmitted to the second device independently, regardless of the A/V content being transmitted to the first sink device.

22. The source device of claim 20, wherein the sharing mode comprises a superimposition mode that requests the A/V content, which is transmitted to the first sink device, be transmitted in superimposition to the second sink device.

23. The source device of claim 20, wherein the sharing mode comprises a redirection mode that requests the A/V content being transmitted to the first sink device be transmitted in succession to the second sink device and stops the transmission to the first sink device.

24. The source device of claim 23, further comprising stopping the transmission of the A/V content to the first sink device.

25. The source device of claim 19, wherein the first processor is configured as a media server control point, and the second processor is configured as a streaming client.

26. A structure of a response message of a sink device for responding to an audio/video (A/V) content information request transmitted to a source device from a sink device, the A/V content information request being a request to share the A/V content via a network, the structure of the response message comprising:
a type field of the requested A/V content; and
a sharing device identifier field indicating a sharing device, which shares the A/V content with the source device.

27. The structure of the response message of claim 26, wherein the response message uses an hyper text transfer protocol (HTTP) response message.

28. A structure of a response message for an audio/video (A/V) content information request transmitted to a source device from a sink device, the A/V content information request being a request to share the A/V content via a network, the structure of the response message comprising:
an information field for identifying A/V content that desires to be shared;
a sharing mode field that shows a sharing type of the A/V content with another sink device; and
a device identifying field to identify the sink device transmitting the request message.

29. The structure of the response message of claim 28, wherein the response message uses an hyper text transfer protocol (HTTP) response message.

30. The structure of the response message of claim 28, wherein a sharing mode comprises a new mode that requests the A/V content to be transmitted to the sink device independently, regardless of the A/V content being transmitted to the another sink device.

31. The structure of the response message of claim 28, wherein the sharing mode includes a superimposition mode that requests the A/V content , which is transmitted to the another sink device, be transmitted in superimposition to the sink device.

32. The structure of the response message of claim 28, wherein the sharing mode includes a redirection mode that requests the A/V content being transmitted to the another sink device be transmitted in succession to the sink device and stops the transmission to the another sink device.
